(19) United States
(12) Patent Application Publication
(10) Pub. No.: US 2007/0294492 A1
(43) Pub. Date: Dec. 20, 2007

(54) Method and apparatus for reducing flash cycles with a generational filesystem

(76) Inventor: John Rudelic, Folsom, CA (US)

Correspondence Address: INTEL CORPORATION;c/o INTELLEVATE, LLC, P.O. BOX 52050, MINNEAPOLIS, MN, 55402, US

(21) Appl. No.: 11/471,421

(22) Filed: Jun. 19, 2006

(51) Int. Cl. G06F 13/00

(52) U.S. Cl. 711/156

(57) ABSTRACT

Briefly, a method, apparatus and system for storing data in a memory array according to an update characteristic of the data is disclosed. By storing data according to, for example, a frequency of update, writes to memory may be more efficient.

### BACKGROUND

### Description of the Related Art

Portable devices store many types of information including, for example, software, configuration data, and user data. Software and configuration data are typically written once and updated infrequently. User data includes data that is also written once and updated infrequently, such as family photos, and data that is written and updated often, such as call lists and application data.

Portable devices typically use non-volatile flash memory for storage of information. Writes to flash memory must be to a blank area of memory because flash memory does not allow overwriting old data. To update information in flash memory, the information to be updated is read, modified, and written to a blank area of memory. The old information is marked as “dirty.”

As blank memory area is reduced, dirty areas must be erased to provide area for new or updated information. A block of flash memory may contain multiple pieces of information as well as dirty areas. Because an entire block of flash memory is erased at one time, valid data stored in the block must be moved to a new location before erasing the block. Information that does not change often may be moved multiple times to free up memory space, often resulting in inefficient flash memory writes. More efficient ways of using flash memory are needed.

### BRIEF DESCRIPTION OF THE DRAWINGS

The present invention may be better understood, and its numerous features and advantages made apparent to those skilled in the art by referencing the accompanying drawings.

FIG. 1 illustrates a block diagram of a portable device according to an embodiment of the present invention.

FIG. 2 illustrates a storage diagram of a memory array according to an embodiment of the present invention.

FIG. 3 illustrates a write flow diagram according to an embodiment of the present invention.

FIG. 4 illustrates a data organizing flow diagram according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

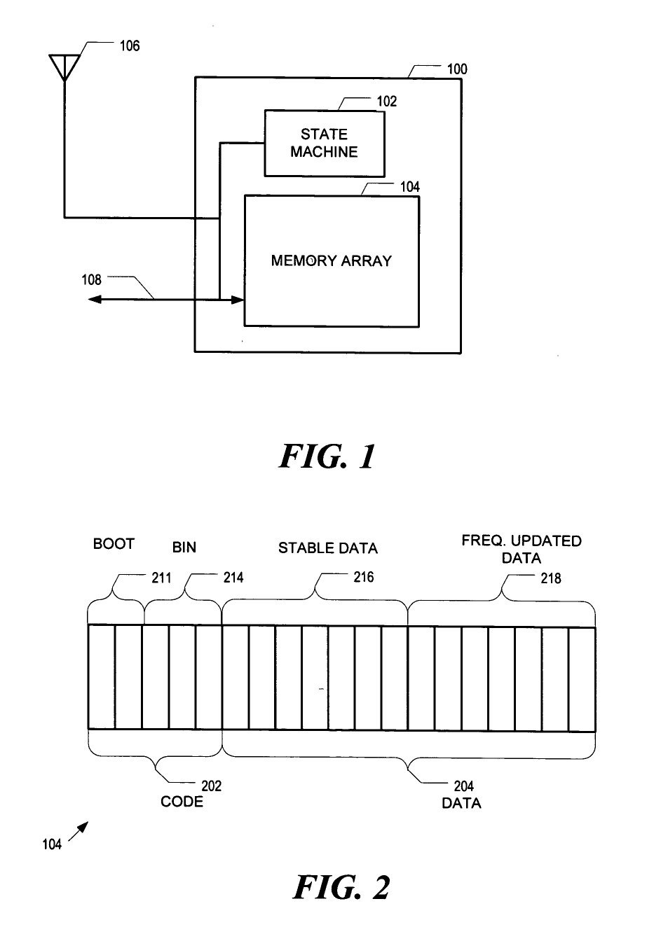

FIG. 1 illustrates a block diagram of a portable device according to an embodiment of the present invention. Device 100 includes a state machine 102 and a memory array 104. State machine 102 and memory array 104 may be included on a single integrated circuit or may be separate components. Memory array 104 may be used to store many types of data including, for example, software, configuration data, and user data. Device 100 may include an antenna 106 and an input/output (IO) port 108. State machine 102 controls the writing and accessing of information stored in memory array 104. State machine 102 may be the main processor for device 100 or may be a processor or simple state machine dedicated for use with memory array 104. Device 100 may include other components such as an additional processor, 10 components, and other components not relevant to the current discussion.

FIG. 2 illustrates a storage diagram of memory array 104 according to an embodiment of the present invention. As illustrated, blocks in memory array 104 are assigned areas for specific types of information, for example, area 202 for code and area 204 for file system data blocks. Area 202 is further divided into blocks 212 for boot code and blocks 214 for binary code. Area 204 is further divided into blocks 216 for stable data and blocks 218 for frequently updated data. Note that partitions illustrated are merely examples and not limited according to embodiments of the present invention. Any area may have more or less blocks. Fewer or additional areas may be used. For example, an additional area may be included for very stable data that has not changed since it was first written. Further, the boundaries between areas may be fluid and shift during use of the memory.

According to one embodiment of the present invention, an update characteristic is tracked for each piece of information. The update characteristic may include time of last update, a frequency of update, the number of times updated since created, and the like. The update characteristic may be metadata and may be stored adjacent to the information, in a different area of the memory array, or even external to the memory array. A memory controller may also track the update characteristic.

According to another embodiment of the present invention, an update characteristic may be stored only for a portion of the information. For example, only update characteristics of frequently updated information are tracked. Stable information may be moved to the frequently updated portion of memory upon a subsequent update.

According to an alternate embodiment of the present invention, update characteristics are derived from the portion of memory the information is currently stored in. For example, upon first write, data may be assumed stable and stored in a stable portion of memory, and then upon subsequent update, moved to the frequently updated portion of memory. Thus, in this embodiment, no explicit update characteristic is stored but instead derived from the current storage location.

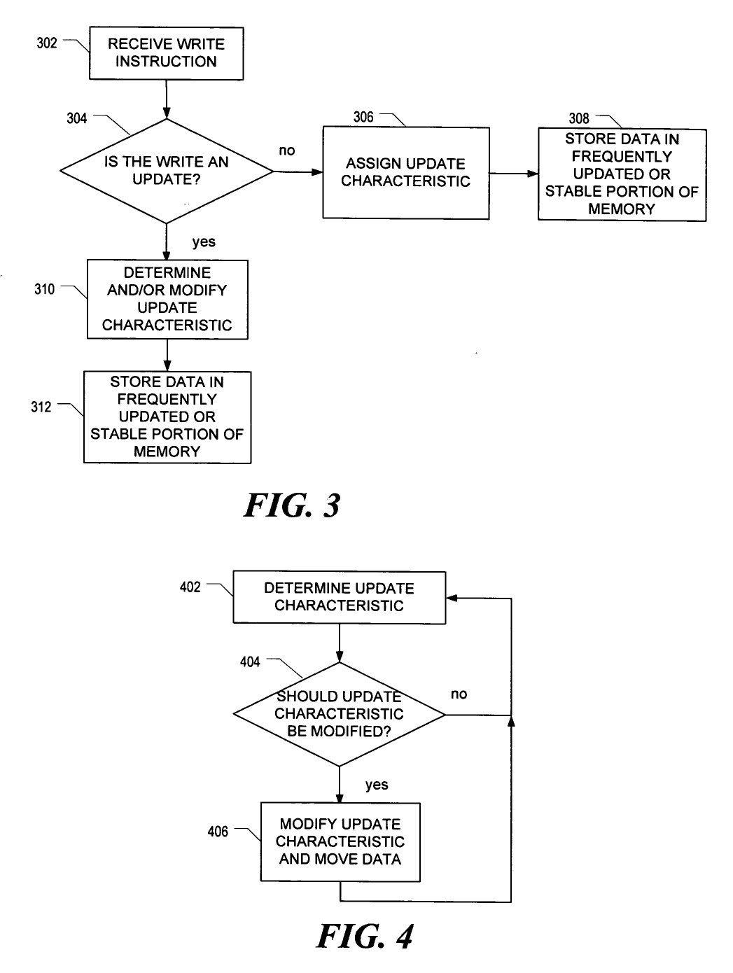

FIG. 3 illustrates a write flow diagram according to an embodiment of the present invention. A write instruction is received, block 302. A determination is made whether the write is an update to existing information or includes new information, block 304. If the write is not an update, the data does not have an update characteristic, and one is assigned, block 306. For example, the data may be assigned a stable update characteristic or a frequently updated characteristic. Further, information may be stored indicating time of update and other such information. The information is written to the frequently updated or stable portion of memory according to its update characteristic, block 308. If the write is an update, the data has an update characteristic which is determined and optionally modified, block 310. For example, if the update characteristic indicates the data is stable, the update characteristic may be modified to indicate frequently updated. The information is written to the frequently updated or stable portion of memory according to its update characteristic, block 312.

FIG. 4 illustrates a data organizing flow diagram according to an embodiment of the present invention. According to some embodiments of the invention, a software routine may monitor the update characteristics of stored information and move the data between the frequently updated and the stable memory portions. An update characteristic of a first piece of information is determined, block 402. For example, a time since last update or a frequency of update may be determined. A determination is made whether the update characteristic should be modified, block 404. For example, information stored in the frequently updated portion of memory may not have been updated for a significant period of time and should be assigned to the stable portion of memory. Alternatively, information stored in the stable portion of memory may indicate a high frequency of update and should be assigned to the frequently updated portion of memory. If the update characteristic should be modified, the update characteristic is modified and the data is moved to the appropriate portion of memory according to the modified update characteristic, block 406. If the update characteristic should not be modified the flow is complete. The flow may be repeated for all information stored in the memory, or just one portion. Alternatively, the flow may be performed during free cycles on one or more pieces of information as time permits.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and data transmission media including permanent and intermittent computer networks, point-to-point telecommunication equipment, carrier wave transmission media, the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few. A typical computing system includes at least one processing unit, associated memory and a number of input/output (I/O) devices. A computing system processes information according to a program and produces resultant output information via I/O devices.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A method comprising:
receiving a request to write information to a memory array;
determining an update characteristic of the information; and
storing the information in a first or second portion of the memory array according to the update characteristic.

2. The method as recited in claim 1, wherein the determining the update characteristic of the information comprises determining whether the information is an update to existing data stored in the memory array or is new data to be stored in the memory array.

3. The method as recited in claim 1, wherein the determining the update characteristic of the information comprises:
determining that the information is an update to existing data stored in the memory array; and
determining the update characteristic of the existing data.

4. The method as recited in claim 3, further comprising:
assigning the update characteristic of the existing data to the information.

5. The method as recited in claim 3, further comprising:
assigning a different update characteristic to the information.

6. The method as recited in claim 3, wherein determining the update characteristic of the existing data comprises deriving the update characteristic based on a location of the existing data in the memory array.

7. The method as recited in claim 1, wherein the determining the update characteristic of the information comprises:
determining that the information is new data to be stored in the memory array; and
assigning the update characteristic to the new data.

8. The method as recited in claim 7, wherein the update characteristic assigned to the new data indicates the data is stable.

9. The method as recited in claim 1, wherein the update characteristic indicates a time since the data has been updated.

10. The method as recited in claim 1, wherein the update characteristic indicates a frequency that the data has been updated.

11. The method as recited in claim 1, wherein the memory array is a flash memory array.

12. The method as recited in claim 1, wherein the update characteristic is stored adjacent to the data.

13. The method as recited in claim 1, wherein the update characteristic is stored external to the memory array.

14. An apparatus comprising:
a memory array; and
a controller configured to:
receive a request to write information to the memory array;
determine an update characteristic of the information; and
store the information in a first or second portion of the memory array according to the update characteristic.

15. The apparatus as recited in claim 14, wherein to determine the update characteristic of the information, the controller is further configured to determine whether the information is an update to existing data stored in the memory array or is new data to be stored in the memory array.

16. The apparatus as recited in claim 14, wherein to determine the update characteristic of the information, the controller is further configured to:
determine that the information is an update to existing data stored in the memory array; and
determine the update characteristic of the existing data.

17. The apparatus as recited in claim 14, wherein to determine the update characteristic of the information, the controller is further configured to derive the update characteristic based on a location of the existing data in the memory array.

18. The apparatus as recited in claim 14, wherein to determine the update characteristic of the information, the controller is further configured to:
determine that the information is new data to be stored in the memory array; and
assign the update characteristic to the new data.

19. The apparatus as recited in claim 18, wherein the update characteristic assigned to the new data indicates the data is frequently updated.

20. The apparatus as recited in claim 14, wherein the update characteristic indicates a time since the data has been updated.

21. The apparatus as recited in claim 14, wherein the update characteristic indicates a frequency that the data has been updated.

22. The apparatus as recited in claim 14, wherein the memory array is a flash memory array.

23. The apparatus as recited in claim 14, wherein the update characteristic is stored adjacent to the data.

24. The apparatus as recited in claim 14, wherein the update characteristic is stored external to the memory array.

25. A system comprising:
a memory array; and
a controller configured to track, assign, and modify update characteristics of data stored in the memory array.

26. The system as recited in claim 25, further comprising an antenna for receiving a request to write the data to the memory array.

27. The system as recited in claim 25, wherein the controller is further configured to:
receive a request to write information to the memory array;
determine an update characteristic of the information; and
store the information in a first or second portion of the memory array according to the update characteristic.

28. The system as recited in claim 27, wherein to determine the update characteristic of the information, the controller is further configured to determine whether the information is an update to existing data stored in the memory array or is new data to be stored in the memory array.

29. The system as recited in claim 27, wherein to determine the update characteristic of the information, the controller is further configured to:
determine that the information is an update to existing data stored in the memory array; and
determine the update characteristic of the existing data.

30. The system as recited in claim 27, wherein the update characteristic indicates a time since the data has been updated.
